(19) United States
(12) Patent Application Publication
(10) Pub. No.: US 2021/0286123 A1
(43) Pub. Date: Sep. 16, 2021

(54) BACKLIGHT MODULE AND DISPLAY DEVICE

(71) Applicant: TCL China Star Optoelectronics Technology Co., Ltd., Shenzhen (CN)

(72) Inventor: Zihang SONG, Shenzhen (CN)

(73) Assignee: TCL China Star Optoelectronics Technology Co., Ltd., Shenzhen (CN)

(21) Appl. No.: 16/625,821

(22) PCT Filed: Dec. 17, 2019
(86) PCT No.: PCT/CN2019/125803

§ 371 Date: Dec. 23, 2019

(30) Foreign Application Priority Data
Nov. 28, 2019 (CN) 201911186790.6

(51) Int. Cl. F21V 8/00

(52) U.S. Cl. CPC G02B 6/0056; G02B 6/005

(57) ABSTRACT

A backlight module and a display device are provided. The backlight module includes: a backlight structure, a polarizer disposed opposite the backlight structure, and an optical film disposed on a surface of one side of the polarizer near the backlight structure.

### FIELD OF THE INVENTION

The present disclosure relates to a field of display, and more particularly to a backlight module and a display device.

### BACKGROUND OF THE INVENTION

A thin film transistor liquid crystal display (TFT-LCD) occupies an important position in today's display industry due to its effective display quality, low harmful radiation, large display area, lightness and thinness, etc. Meanwhile, quantum dots as a kind of luminous material with high luminous efficiency, high chromatographic purity, and adjustable luminous wavelength, currently attract widespread attention. Applying them to the TFT-LCD can greatly increase color gamut and color performance of the LCD display.

As shown in FIG. 1, a conventional display device generally includes a polarizer 100, a backlight structure 300 and a display panel 200. The polarizer 100 is a quantum dot polarizer. The working principle is that blue backlight excites a red-green-mixed quantum dot optical film, finally to mix and form white light. The color gamut of the LCD display is increased due to high chromatographic purity of red, green and blue. However, putting the quantum dot optical film into the backlight may lose the unique advantage of large viewing angles of the quantum dots. Based on this, the quantum dot polarizer increases the color gamut of the LCD display and still retains the advantage of large viewing angles of the quantum dots.

Since the quantum dots are luminous “spheres”, the light toward the LCD panel in the quantum dot polarizer directly transmits through the LCD panel, but the light toward the backlight direction reaches a reflective sheet after passing through a series of optical films, such as diffusers, prism sheets, and light guide plates, etc. By the reflection effect of the reflective sheet, the light can transmit through the series of optical films and the LCD panel again. This part of light suffers a large loss after passing through the optical films in the backlight, thereby causing entire reduction of light efficiency. As a result, improving the light loss in this part is of great significance for increasing the light efficiency.

### SUMMARY OF THE INVENTION

Technical problems: The object of the present disclosure is to solve the technical problems of serious light loss and low light efficiency in the current backlight module.

Technical solutions: To achieve the above object, the present disclosure provides a backlight module including a backlight structure; a polarizer disposed opposite the backlight structure; and an optical film disposed on a surface of one side of the polarizer near the backlight structure.

Further, the optical film is a short-pass filter.

Further, the transmission wavelength band of the short-pass filter ranges from 0 to 500 nanometers.

Further, the reflection wavelength band of the short-pass filter ranges from 500 nm to 1000 nm.

Further, the backlight structure includes: a reflective sheet; a light source layer disposed on a surface of one side of the reflective sheet; a first diffusion sheet disposed on a surface of one side of the light source layer away from the reflective sheet; a prism sheet disposed on a surface of one side of the first diffusion sheet away from the light source layer; and a second diffusion sheet disposed on a surface of one side of the prism sheet away from the first diffusion sheet.

Further, the optical film is disposed between the second diffusion sheet and the polarizer.

Further, the polarizer includes red quantum dots and green quantum dots.

To achieve the above object, the present disclosure further provides a display device including the backlight module described above.

Further, the display device further includes a display panel.

Further, the backlight module includes a backlight structure, a short-pass filter, and a polarizer; and the display panel is disposed on a surface of one side of the polarizer away from the short-pass filter.

Beneficial effect: The technical effect of the present disclosure is that a short-pass filter is disposed between the polarizer and the backlight structure, such that red light and green light cannot be transmitted. The red light and the green light emitted by the red-green quantum dots in the quantum dot polarizer are reflected upward, and the loss which the light emitted by the quantum dots suffers in the backlight module is reduced, thereby increasing the light efficiency of the display device. Because the blue light is in the transmission wavelength band range of the short-pass filter, the blue light can pass through the short-pass filter without hindrance, thereby exciting the red-green quantum dots, and further increasing the light efficiency of the display device.

### DESCRIPTION OF THE DRAWINGS

FIG. 1 is a structural diagram of a display device in the prior art.

FIG. 2 is a schematic structural diagram of a display device according to an embodiment of the present disclosure.

FIG. 3 is a transmission spectrum of a short-pass filter according to an embodiment of the present disclosure.

FIG. 4 is a schematic structural diagram of a display panel according to an embodiment of the present disclosure.

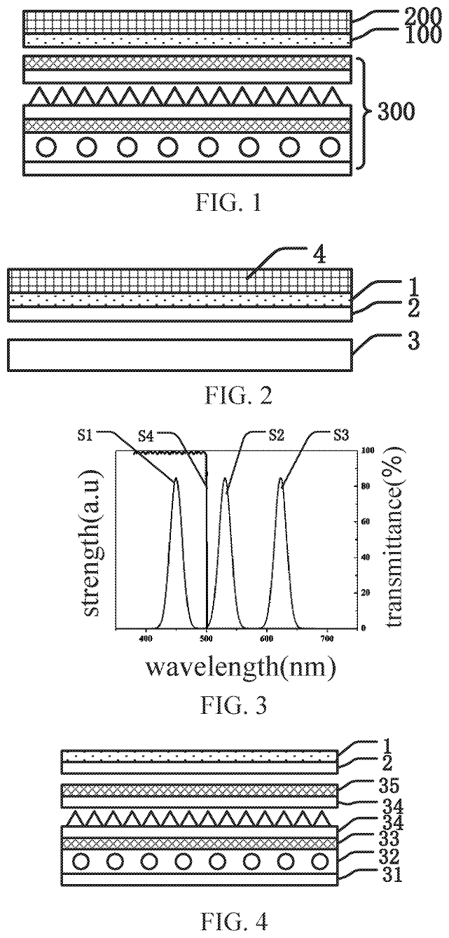

Some components are labeled as follows:

100, polarizer; 200, display panel; 300, backlight structure;

1, polarizer; 2, optical film; 3, backlight structure; 4, display panel;

31, reflective sheet; 32, light source layer; 33, first diffusion sheet; 34, prism sheet; 35, second diffusion sheet;

S1, transmission spectrum of blue light; S2, transmission spectrum of green light; S3, transmission spectrum of red light; S4, transmission spectrum of short-pass filter.

### DETAILED DESCRIPTION OF THE PREFERRED EMBODIMENTS

The preferred embodiments of the present disclosure are described in detail below with reference to the accompanying drawings, so as to fully introduce the technical contents of the present disclosure to those skilled in the art, and to exemplify that the present disclosure can be implemented, such that the technical contents of the present disclosure are more clear, and those skilled in the art more readily understand how to implement the disclosure. However, the present disclosure may be embodied in many different forms of embodiments, and the scope of the present disclosure is not limited to the embodiments described herein. The description of the embodiments below is not intended to limit the scope of the present disclosure.

The directional terms mentioned in the present disclosure, such as “upper”, “lower”, “front”, “back”, “left”, “right”, “inside”, “outside”, “side”, etc. are only direction with regard to the accompanying drawings. The directional terms herein used for explaining and illustrating the present disclosure are not intended to limit the scope of present disclosure.

In the drawings, structurally identical components are denoted by the same reference numerals, and structural or functionally similar components are denoted by similar reference numerals. Moreover, the size and thickness of each component shown in the drawings are arbitrarily illustrated for ease of understanding and description. The present disclosure does not limit the size and thickness of each component.

When a component is described as “on” another component, the component can be placed directly on the other component. There can also be an intermediate component which the component is placed thereon, and the intermediate component is placed on another component. When a component is described as “mounted to” or “connected to” another component, they can be understood as directly “mounted to” or “connected to”, or a component is “mounted to” or “connected to” another component through an intermediate component.

As shown in FIG. 2, the embodiment provides a display device including a backlight module and a display panel 4. The backlight module includes a polarizer 1, an optical film 2, and a backlight structure 3.

The polarizer 1 is a red-green quantum dot polarizer. The red-green quantum dots emit red light and green light after being excited, for imaging of a liquid crystal display. The polarizer 1 can convert natural light into linear polarized light. Light spots in each light spot group in the display panel 2 are independently responsible for display of selected color and brightness of light. The function of the polarizer 1 is to separate incident linear light using polarized components, such that one part thereof passes the polarizer and another part of light is absorbed, reflected, and scattered etc. by the polarizer, so as to be concealed, color-split and pressure-reduced, thereby controlling image effect of imaging.

The optical film 2 is disposed on a lower surface of the polarizer 1. In this embodiment, the optical film 2 is a short-pass filter. The short-pass filter is a multilayer-structured optical film in which different refractive index films are alternately stacked, and an optical film which can transmit light in short wavelength band and reflect light in long wavelength band. Adjustment of the wavelength band can be realized through adjustment of refractive index and design of layer number.

As shown in FIG. 3, a transmission spectrum of the short-pass filter is shown. The transmission wavelength band of the short-pass filter ranges from 0 to 500 nanometers (nm), and the reflection wavelength band of the short-pass filter ranges from 500 nm to 1000 nm. S1 is a transmission spectrum of blue light, and the wavelength band of the blue light ranges from 400 nm to 500 nm. S2 is a transmission spectrum of green light, and the wavelength band of the green light ranges from 500 nm to 560 nm. S3 is a transmission spectrum of red light, and the transmission spectrum of the red light ranges from 560 nm to 650 nm. S4 is a transmission spectrum of the short-pass filter. Obviously, the blue light is in the transmission wavelength band range of the short-pass filter, and the green light and the red light are in the reflection wavelength band range of the short-pass filter, so that the blue light can be transmitted, while the green light and the red light is reflected.

When the red-green quantum dots in the polarizer 1 emit light, as being downward incident on the short-pass filter, the red light and the green light are reflected upward, without having to pass through films, such as the diffusion sheet, the prism sheet, etc. in the backlight module. The loss of the quantum dot light emission in the backlight module can be reduced, thereby increasing the light efficiency of the display device.

As shown in FIG. 4, the backlight structure 3 is disposed below the short-pass filter. The backlight structure 3 includes a reflective sheet 31, a light source layer 32, a first diffusion sheet 33, a prism sheet 34, and a second diffusion sheet 35.

The reflective sheet 31 is used to upward reflect the light emitted from the bottom surface of the display device to increase usage efficiency of the light. For equal luminous brightness in the same area, the higher the light emission efficiency, the lower the power consumption of the display device.

The light source layer 32 is disposed on an upper surface of the reflective sheet 31. A plurality of light sources are provided in the light source layer 32. The light sources can emit light. One part of the emitted light is emitted downward, and is reflected back by the reflective sheet 31 below, and another part of the light and the light reflected back are emitted upward together.

The first diffusion sheet 33 is disposed on an upper surface of the light source layer 32 to provide a uniform surface light source for the display device. The working principle of the diffusion sheet is to atomize the light source by refraction and reflection of diffusive substances, and to emit the light from a small angle and to focus the light on a front to increase the front brightness. In this embodiment, the first diffusion sheet 33 is a lower diffusion sheet, and the lower diffusion sheet mainly focuses the light emitted from the light source layer 32 and uniformly project the light onto the prism sheet 34.

The prism sheet 34 is disposed on an upper surface of the first diffusion sheet 33, and a plurality of small triangles are arranged in the middle of the prism sheet 43, such that light can be emitted in different angles. The prism sheet 34 is also a brightness enhancement sheet and is an important element of the backlight module of the liquid display device. In order to take a spotlight effect, the prism sheet 34 mainly focuses the scattered light onto a certain angle range by using the laws of total reflection and refraction, and emits the focused light, thereby increasing the brightness in the range.

The second diffusion sheet 35 is disposed on an upper surface of the prism sheet 34 and disposed below the optical film 2 to provide a uniform surface light source for the display device. The working principle of a diffusion sheet is to atomize a light source by refraction and reflection of diffusing substances, and to emit the light from a small angle and to focus the light on a front to increase the front brightness. In this embodiment, the second diffusion sheet 35 is an upper diffusion sheet. The main function of the upper diffusion sheet is to atomize the light emitted from the prism sheet 34 and uniformly transmit the light, and also to protect the prism sheet 34.

The technical effect of the display device described in this embodiment is that a short-pass filter is disposed between the polarizer and the backlight structure, such that red light and green light cannot be transmitted. The red light and the green light emitted by the red-green quantum dots in the quantum dot polarizer are reflected upward, and the loss which the light emitted by the quantum dots suffers in the backlight module is reduced, thereby increasing the light efficiency of the display device. Because the blue light is in the transmission wavelength band range of the short-pass filter, the blue light can pass through the short-pass filter without hindrance, thereby exciting the red-green quantum dots, and further increasing the light efficiency of the display device.

The above description is only a preferred embodiment of the present disclosure, and it should be noted that those skilled in the art can also make several improvements and retouches without departing from the principles of the present disclosure. These improvements and retouches should also be considered as the protection scope of the present disclosure.

What is claimed is:

1. A backlight module, comprising:
a backlight structure;
a polarizer disposed opposite the backlight structure; and
an optical film disposed on a surface of one side of the polarizer near the backlight structure.

2. The backlight module as claimed in claim 1, wherein the optical film is a short-pass filter.

3. The backlight module as claimed in claim 2, wherein the transmission wavelength band of the short-pass filter ranges from 0 to 500 nanometers.

4. The backlight module as claimed in claim 2, wherein the reflection wavelength band of the short-pass filter ranges from 500 nm to 1000 nanometers.

5. The backlight module as claimed in claim 1, wherein the backlight structure includes:
a reflective sheet;
a light source layer disposed on a surface of one side of the reflective sheet;
a first diffusion sheet disposed on a surface of one side of the light source layer away from the reflective sheet;
a prism sheet disposed on a surface of one side of the first diffusion sheet away from the light source layer; and
a second diffusion sheet disposed on a surface of one side of the prism sheet away from the first diffusion sheet.

6. The backlight module as claimed in claim 5, wherein the optical film is disposed between the second diffusion sheet and the polarizer.

7. The backlight module as claimed in claim 1, wherein the polarizer includes red quantum dots and green quantum dots.

8. A display device comprising the backlight module as claimed in claim 1.

9. The display device as claimed in claim 8, further comprising a display panel.

10. The display device as claimed in claim 9, wherein the backlight module includes the backlight structure, a short-pass filter, and the polarizer; and
the display panel is disposed on a surface of one side of the polarizer away from the short-pass filter.
